(19) United States
(12) Patent Application Publication
(10) Pub. No.: US 2020/0159622 A1
(43) Pub. Date: May 21, 2020

(54) RULE BASED FAILURE ADDRESSING

(71) Applicant: Hewlett Packard Enterprise Development LP, Houston, TX (US)

(72) Inventors: Murali Mohan Chakravarthy Chintagunta, Bangalore (IN); Prasanna Sheshagiri Bhat, Bangalore (IN); Rakesh Podili, Bangalore (IN)

(21) Appl. No.: 16/194,542

(22) Filed: Nov. 19, 2018

(51) Int. Cl. G06F 11/14; G06F 11/07; G06F 17/27

(52) U.S. Cl. CPC G06F 11/142; G06F 17/2705; G06F 11/0769; G06F 11/1479

(57) ABSTRACT

Example implementations relate to rule based failure addressing. A computing device may comprise a processing resource and a memory resource storing non-transitory machine-readable instructions to cause the processing resource to receive an error code corresponding to a failure during an execution of a software application, determine, based on a keyword included in the error code, a rule from a configuration file to execute to address the failure, and execute the rule to address the failure to cause execution of the software application.

### BACKGROUND

Software applications can be made to work in various environments. For example, software applications may be run on different operating systems, hardware platforms, databases, network environments having fluctuating conditions, as well as varying memory and computer processing unit (CPU) hardware amounts and hardware resource usage amounts.

### BRIEF DESCRIPTION OF THE DRAWINGS

FIG. 1 illustrates an example system consistent with the disclosure.

FIG. 2 illustrates an example system consistent with the disclosure.

FIG. 3 is a block diagram of an example computing device for rule based failure addressing consistent with the disclosure.

FIG. 4 is a block diagram of an example system consistent with the disclosure.

FIG. 5 illustrates an example method consistent with the disclosure.

### DETAILED DESCRIPTION

A software application can be run in different environments to perform various functions. As used herein, the term “software application” refers to a set of instructions that are executed by a processor to perform a group of coordinated functions, tasks, and/or activities. For example, a software application may be utilized to perform cloud computing applications, web services applications, database management, among other functions by a computing device.

During execution of software applications in various environments, failures during a runtime of the software application may occur. As used herein, the term “failure” refers to an inability to perform a function, task, and/or activity by a set of instructions to perform the function, task, and/or activity. For example, during a runtime of the software application or during runtime of a software module within the software application, the software application may fail to perform a particular function, task, and/or activity.

In some examples, the software application may include a retry mechanism. For example, the software application may retry performing a task by performing a same set of instructions to perform the task. However, retrying performance of the task using the same set of instructions may not fix a failure of the software application. For instance, the same set of instructions may be executed to perform the task without any other change in execution variables, such as the software application, hardware running the software application, network environment, and/or hardware environment. Without changing one of the variables described above, the failure may be repeated.

In some examples, changing an execution variable above may cause instructions comprising the software application to have to be re-compiled. As used herein, the term “compiling” refers to converting programming instructions into a machine-readable code to be read and/or executed by a processing device. As used herein, the term “execute” refers to a process by which a processor of a computing device carries out machine-readable instructions of a script, software application, etc. Re-compiling the instructions comprising the software application to address a failure can be time and/or resource consuming and may generate additional unintended errors as a result.

Rule based failure addressing, according to the disclosure, can allow for failure addressing of a software application without having to re-compile the instructions comprising the software application. A strategy based retry mechanism having various rules can allow for a computing device to address a failure based on an error code associated with the failure. Accordingly, a failure in the execution of a software application can be addressed using the various rules based on an error code of a failure, which can allow the software application to “self-heal”. As a result, software application efficiency and robustness can be increased, and the software application can be delivered to various environments without re-compiling.

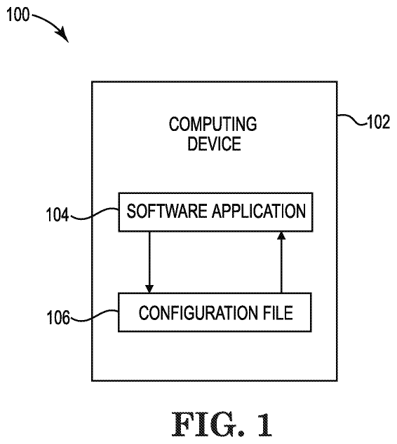

FIG. 1 illustrates an example system 100 consistent with the disclosure. As illustrated in FIG. 1, the system 100 can include computing device 102, software application 104, and configuration file 106.

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized for rule based failure addressing. For example, computing device 102 can be utilized to execute rules to address failures during execution of a software application 104, as is further described herein. As described above, a software application 104 can include a set of instructions that are executed by a processor to perform a task. If a failure occurs during a runtime of the software application 104, computing device 102 can execute rules to address the failure, as is further described herein. Further, in some examples, a software application 104 may include modules within the software application 104. As used herein, the term “software module” refers to a subset of instructions that are executed by a processor to perform a sub-group of coordinated functions, tasks, and/or activities within the context of the greater software application. If, for example, a failure occurs during a runtime of a module within the software application 104, computing device 102 can execute rules to address the failure.

In some examples, a failure can be a transient failure. A transient failure can be a temporary failure which may be due to infrastructure. For example, software application 104 may utilize computing device 102 to communicate information over a network. The network can be, for example, a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of networks. Computing device 102 may transmit information (e.g., a packet) over the network while the network is down, which can result in a dropped packet. As a result of the dropped packet, a failure may occur which can result in an error code being generated, as is further described herein.

Although a transient failure is described above as being a dropped packet, examples of the disclosure are not so limited. For example, a transient failure can be any other temporary failure which may be due to infrastructure issues (e.g., network, hardware, etc.)

In some examples, a failure can be a fault. A fault can be a software issue. For example, a fault may include a missing file, rest network connection, a database entry being empty, among other types of faults. As a result of a fault, a failure may occur which can result in an error code being generated, as is further described herein.

As described above, a failure of an execution of a software application 104 can occur in different ways. As a result of the failure of the execution of the software application 104, an error code may be generated. As used herein, the term “error code” refers to an enumerated message that corresponds to a status of a particular software application 104. For example, in an instance in which failure of execution of software application 104 occurs as a result of a particular file missing, an error code may be generated that indicates the failure as a result of the particular file missing.

Computing device 102 can receive the error code corresponding to the failure during an execution of software application 104. For example, the particular missing file can generate an error code indicating the particular file is missing. The error code can be, for example, “error:“FileNotFoundException””, among other error codes corresponding to different types of failures.

As a result of the error code, computing device 102 can determine a rule based on a keyword included in the error code. As used herein, the term “keyword” refers to a word that serves as an indicator as to the meaning of another word, sentence, passage, etc. For example, as described above, the error code may include “FileNotFoundException”, where the keyword can be “FileNotFound”.

Although the error code and/or keyword are described above as being a single error code and/or keyword, examples of the disclosure are not so limited. For example, a failure can generate an error code having multiple keywords.

Utilizing the keyword “FileNotFound”, computing device 102 can determine a particular rule based on the keyword included in the error code. As used herein, the term “rule” refers to a set of instructions executed by a computing device 102. For example, a rule can be a script. The rule can be executed to perform a certain task, such as address a failure during execution of software application 104, as is further described herein.

The rule can be stored in a configuration file 106. As used herein, the term “configuration file” refers to a file used to modify parameters and settings of a software application. Configuration file 106 can be a parsable file. That is, configuration file 106 can be a file that is readable by computing device 102. For example, configuration file 106 can include rules used to modify parameters and/or settings of software application 104. The rules can modify parameters and/or settings of software application 104 in order to address a failure of software application 104, as is further described herein.

In some examples, the configuration file 106 can be a text (TXT) file. As used herein, the term “text file” (e.g., TXT file) refers to a computer file that is structured as a sequence of lines of electronic text. For example, the configuration file 106 can include a plurality of rules structured as sequences of lines of electronic text.

In some examples, the configuration file 106 can be a JavaScript Object Notation (JSON) file. As used herein, the term “JavaScript Object Notation file” (e.g., JSON file) refers to a computer file having human-readable text to transmit data objects having attribute-value pairs and array data types. For example, the configuration file 106 can include a plurality of rules structured as data objects having attribute-value pairs and array data types.

In some examples, the configuration file 106 can be an Extensible Markup Language (XML) file. As used herein, the term “Extensible Markup Language file” (e.g., XML file) refers to a computer file representing electronic office documents. For example, the configuration file 106 can include a plurality of rules structured as electronic office documents.

Although the configuration file 106 is described above as being a TXT, JSON, and/or an XML file, examples of the disclosure are not so limited. For example, the configuration file 106 can be any other parsable file type suitable to include rules.

As described above, each rule included in the configuration file 106 can be executed to perform a certain task, such as addressing a failure during execution of software application 104. Accordingly, each rule can be associated with a particular error code. A failure can have a particular failure type. For example, the failure error code “FileNotFoundException” can have a failure type “file missing”. The keyword “FileNotFound” of the failure code “FileNotFoundException” can be associated with the particular failure type (e.g., file missing) of the failure.

Although a particular failure is described above as having an associated rule, examples of the disclosure are not so limited. For example, a particular failure can have more than one associated rule. For instance, the particular failure having an error code “FileNotFoundException” may include multiple rules executable to address the particular failure, as is further described herein.

As described above, each rule can be associated with a particular error code. Additionally, each rule can include a particular retry strategy and a rule execution order. As used herein, the term “retry strategy” refers to a particular series of steps to address a particular failure. A retry strategy can include a retry method, retry count, and/or a delay between retries, as is further described herein. As used herein, the term “rule execution order” refers to a disposition of rules following one after another.

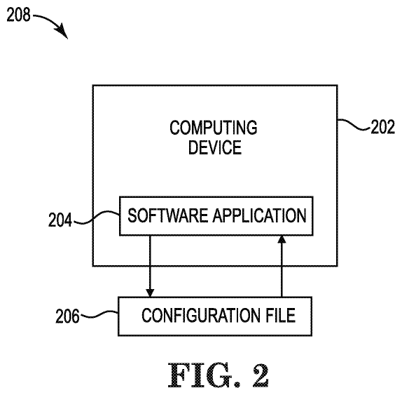

As illustrated in FIG. 1, configuration file 106 can be stored locally on computing device 102. For example, configuration file 106 can be stored in memory located in computing device 102. However, examples of the disclosure are not so limited. For example, configuration file 106 can be stored externally from computing device 102, as is further described in connection with FIG. 2.

Configuration file 106 can be modifiable. For example, configuration file 106 can be modified by adding rules to the configuration file 106 and/or removing rules from the configuration file 106. Configuration file 106 can be modified by a user, such as a network administrator or other user having administrative privileges, in order to address failures of software application 104. For instance, software application 104 may experience a failure and configuration file 106 may not have a rule to address the failure. In such an example, a rule can be added to the configuration file 106 that is executable to address the failure. In some examples, the rule may be a script outside of software application 104 to address the failure.

Configuration file 106 can be modified without re-compiling instructions comprising the software application 104. For example, a rule can be added to configuration file 106 to address a failure software application 104 may encounter without having to re-compile software application 104. As a result, modification of instructions comprising software application 104 can be avoided, avoiding lengthy re-compiling of software application 104 which may take time and computing resources.

Continuing with the example from above, based on the keyword “FileNotFound” for an error code “FileNotFoundException” corresponding to a failure of software application 104, a rule stored in configuration file 106 can be determined. For example, Rule 1 can be determined, and can be formatted as follows:

Rule 1: 1# module: “load_configuration_data”, error:“FileNotFoundException”, retry_strategy:“create_config_file”, retry_count: “2”, delay “2”, default_retry:“true”

Computing device 102 can execute the rule to address the failure to cause execution of software application 104. For example, Rule 1, stored in configuration file 106, can be executed by performing instructions comprising Rule 1 to address a failure of software application 104 having an associated error code according to the retry strategy and rule execution order described above. For example, the error code “FileNotFoundException” can be associated with a failure of software application 104 (e.g., due to a file being missing) during execution of software application 104. Further, the retry strategy based on the error code can be creating a configuration file (e.g., create_config_file), trying to create the configuration file twice with a two second delay between each retry, where Rule 1 is the default rule for the failure having error code “FileNotFoundException”.

As described above, Rule 1 can be a default rule for the error code “FileNotFoundException”. As used herein, the term “default” refers to a rule first used based on a particular error code.

In some examples, a particular failure having an associated error code can include multiple rules executable to address the particular failure. For example, a failure of software application 104 can have an error code “401”. The error code 401 can be associated with a failure to connect to a web server, for example. In such an example, configuration file 106 may determine three rules executable to address the failure. The three rules can be as follows:

Rule 1: 1# module: “connect_to_webserver”, error:“401”, retry_strategy:“retry_with_samecreds”, retry_count: “2”, delay “10”, default_retry:“true”
Rule 2: 2# module: “connect_to_webserver”, error:“401”, retry_strategy:“retry_with_differentcreds”, retry_count: “2”, delay “10”, default_retry:“false”
Rule 1: 3# module: “connect_to_webserver”, error:“401”, retry_strategy:“retry_with_LDAPcreds”, retry_count: “2”, delay “10”, default_retry:“false”

For example, the error code “401” can be associated with a failure of software application 104 to connect to a web server during execution of software application 104. According to Rule 1, Rule 1 can be the default rule having a retry strategy including retrying the login to the web server using the same access credentials (e.g., retry_with_samecreds), retrying the login to the web server twice, and retrying the login to the web server using the same access credentials with a ten second delay between each retry.

In some examples, computing device 102 can determine a second rule from configuration file 106 in response to Rule 1 failing to address the failure. That is, in response to the execution of Rule 1 not causing a successful execution of software application 104, Rule 2 can be executed after Rule 1 according to the rule execution order. According to Rule 2, Rule 2 can be the first rule executed following the default rule, where Rule 2 has a retry strategy including retrying the login to the web server using different access credentials (e.g., retry_with_differentcreds), retrying the login to the web server twice, and retrying the login to the web server using the different access credentials with a ten second delay between each retry.

Additionally, in some examples computing device 102 can determine a third rule from configuration file 106 in response to the execution of Rule 2 not causing a successful execution of software application 104. That is, in response to execution of Rule 1 and execution of Rule 2 not causing a successful execution of software application 104, Rule 3 can be executed after Rule 1 and Rule 2 according to the rule execution order. According to Rule 3, Rule 3 can be the second rule executed following the default rule, where Rule 3 has a retry strategy including retrying the login to the web server using lightweight directory access protocol (LDAP) access credentials (e.g., retry_with_LDAPcreds), retrying the login to the web server twice, and retrying the login to the web server using the LDAP access credentials with a ten second delay between each retry.

As described above, Rules 1, 2, and 3 can include a predefined rule execution order. The Rules 1, 2, and 3 can be executed in the predefined rule execution order until a particular rule in the group of rules causes a successful execution of software application 104. For example, if Rule 1 does not cause a successful execution of the software application, Rule 2 can be executed to cause a successful execution of the software application. Further, if Rule 2 does not cause a successful execution of the software application 104, Rule 3 can be executed to cause a successful execution of the software application 104. Further, although described above as including three rules, examples of the disclosure are not so limited. For example, a particular failure having an error code can include more than three rules which can be executed in a predefined execution order until a particular one of the more than three rules causes a successful execution of the software application 104.

Rule based failure addressing, according to the disclosure, can allow for a software application to “self-heal”. For example, the software application 104, when encountering a failure, can utilize different retry mechanisms based on a particular error code associated with the failure. The retry mechanisms can be rules stored in a configuration file 106. The different rules can be executed until the software application 104 has successfully executed. Further, the configuration file 106 can be modified to allow for the addition and/or removal of rules.

Rule based failure addressing, according to the disclosure, can provide increased robustness to software applications in order to handle various types of failures that may be experienced during execution of software applications. Further, software application quality, maintainability, and adaptiveness can be enhanced, allowing software applications to be reliably executed, enhancing a customer experience and reducing time, effort, and customer support resources.

FIG. 2 illustrates an example system 208 consistent with the disclosure. As illustrated in FIG. 2, the system 208 can include computing device 202, software application 204, and configuration file 206.

As illustrated in FIG. 2, configuration file 206 can be located externally from computing device 202. For example, configuration file 206 can be located in an external server which may be connected to computing device 202 via a network.

In an example such as that illustrated in FIG. 2, configuration file 206 may be a proprietary configuration file. For example, computing device 202 may be a customer computing device executing software application 204 and, when software application 204 encounters a failure, can access the proprietary configuration file 206 via the network. In such an example, rules may be added to/removed from configuration file 206 for use by customers executing software application 204 without granting customer access to the configuration file 206.

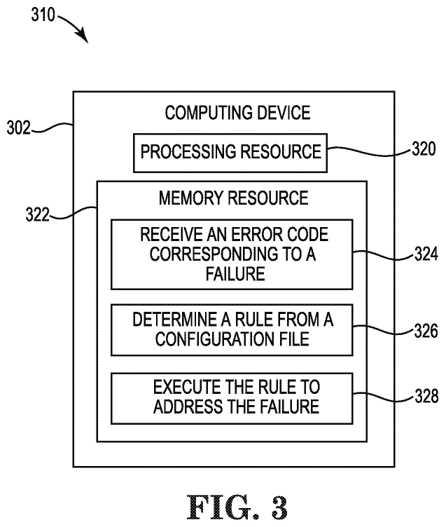

FIG. 3 is a block diagram 310 of an example computing device 302 for rule based failure addressing consistent with the disclosure. As described herein, the computing device 302 may perform a number of functions related to rule based failure addressing. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and the computing device 302 may be distributed across multiple processors. Put another way, the instructions executed by the computing device 302 may be stored across multiple machine-readable storage mediums and executed across multiple processors, such as in a distributed or virtual computing environment.

As illustrated in FIG. 3, the computing device 302 may comprise a processing resource 320, and a memory resource 322 storing machine-readable instructions to cause the processing resource 320 to perform a number of operations related to rule based failure addressing. That is, using the processing resource 320 and the memory resource 322, the computing device 302 may execute a rule to address a failure of a software application, among other operations. Processing resource 320 may be a central processing unit (CPU), microprocessor, and/or other hardware device suitable for retrieval and execution of instructions stored in memory resource 322.

The computing device 302 may include instructions 324 stored in the memory resource 322 and executable by the processing resource 320 to receive an error code corresponding to a failure. The failure can be encountered during execution of a software application by computing device 302. As a result of the failure, an error code may be generated. The error code can include a keyword, as is further described herein.

The computing device 302 may include instructions 326 stored in the memory resource 322 and executable by the processing resource 320 to determine a rule from a configuration file. For example, an error code can have an associated keyword. A rule stored in the configuration file can be associated with a particular keyword. For example, a rule can be a set of instructions executable to address a particular failure having a keyword associated with the rule. The configuration file can be located locally on computing device 302 or be located externally from computing device 302. In some examples, the configuration file can be modified to add and/or remove rules.

The computing device 302 may include instructions 328 stored in the memory resource 322 and executable by the processing resource 320 to execute the rule to address the failure. For example, computing device 302 can execute the rule to address the failure such that execution of the software application can be performed. In this manner, computing device 302 can address failures in execution of the software application.

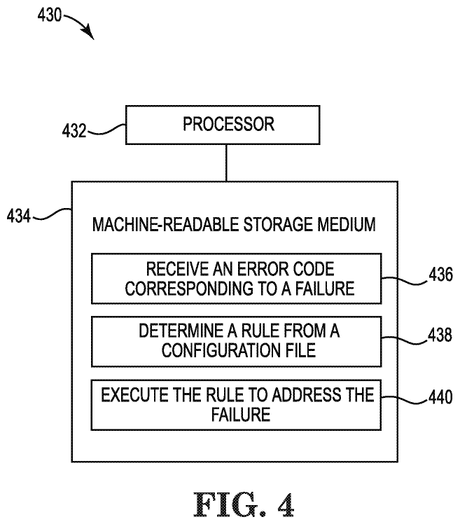

FIG. 4 is a block diagram of an example system 430 consistent with the disclosure. In the example of FIG. 4, system 430 includes a processor 432 and a machine-readable storage medium 434. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 432 may be a central processing unit (CPU), microprocessor, and/or other hardware device suitable for retrieval and execution of instructions stored in machine-readable storage medium 434. In the particular example shown in FIG. 4, processor 432 may receive, determine, and send instructions 436, 438, and 440. As an alternative or in addition to retrieving and executing instructions, processor 432 may include an electronic circuit comprising a number of electronic components for performing the operations of the instructions in machine-readable storage medium 434. With respect to the executable instruction representations or boxes described and shown herein, it should be understood that part or all of the executable instructions and/or electronic circuits included within one box may be included in a different box shown in the figures or in a different box not shown.

Machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. Machine-readable storage medium 434 may be a portable, external or remote storage medium, for example, that allows the system 430 to download the instructions from the portable/external/remote storage medium. In this situation, the executable instructions may be part of an “installation package”. As described herein, machine-readable storage medium 434 may be encoded with executable instructions for rule based failure addressing.

Receive instructions 436, when executed by a processor such as processor 432, may cause system 430 to receive an error code corresponding to a failure. The failure can be a failure during an execution of a software application. As a result of the failure, an error code may be generated. The error code can include a keyword, as is further described herein.

Determine instructions 438, when executed by a processor such as processor 432, may cause system 430 to determine a rule from a configuration file. The rule can be determined based on the keyword included in the error code. The rule can be determined from a plurality of rules included in a modifiable configuration file that can be executed to address the failure.

Execute instructions 440, when executed by a processor such as processor 432, may cause system 430 to execute the rule to address the failure. That is, the rule can be executed to cause execution of the software application.

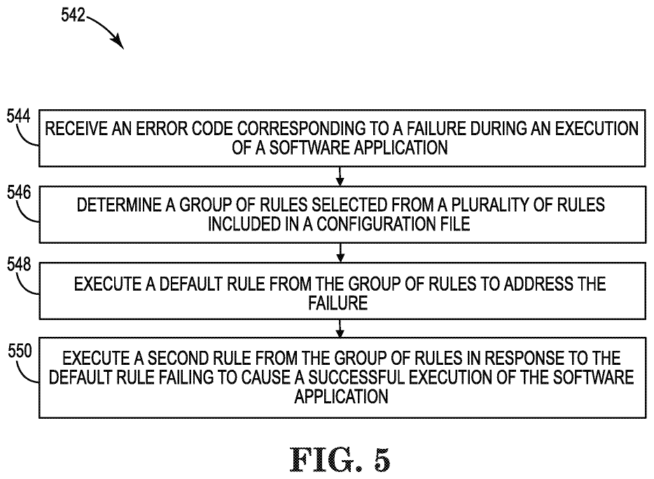

FIG. 5 illustrates an example method 542 consistent with the disclosure. Method 542 may be performed, for example, by a computing device (e.g., computing device 102, 202, 302, previously described in connection with FIGS. 1, 2, and 3, respectively).

At 544, the method 542 may include receiving an error code corresponding to a failure during an execution of a software application. The error code can be generated as a result of a particular failure of the software application. For example, a first type of failure can generate a first type of error code, a second type of failure can generate a second type of error code, etc.

At 546, the method 542 may include determining a group of rules selected from a plurality of rules included in a configuration file. The group of rules can be selected based on a keyword included in the error code generated as a result of the particular failure of the software application.

At 548, the method 542 may include executing a default rule from the group of rules to address the failure. Executing the default rule can cause execution of the software application.

At 550, the method 542 may include executing a second rule from the group of rules in response to the default rule failing to cause a successful execution of the software application. For example, if the default rule does not cause a successful execution of the software application (e.g., the failure re-occurs), a second rule can be executed following the default rule. The second rule can be executed according to a predefined rule execution order. The predefined rule execution order can include a list of rules that can be executed in the order until a successful execution of the software application occurs (e.g., the failure does not occur).

In some examples, the method 542 can include modifying the configuration file by adding a rule to the configuration file. The added rule can be executed to cause execution of the software application.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
receive an error code corresponding to a failure during an execution of a software application;
determine, based on a keyword included in the error code, a rule from a configuration file to execute to address the failure; and
execute the rule to address the failure to cause execution of the software application.

2. The computing device of claim 1, wherein the configuration file is modifiable.

3. The computing device of claim 2, including instructions to cause the processing resource to modify the configuration file by adding an additional rule to the configuration file.

4. The computing device of claim 2, including instructions to cause the processing resource to modify the configuration file by removing a rule from the configuration file.

5. The computing device of claim 1, including instructions to cause the processing resource to determine, in response to the rule from the configuration file failing to address the failure, another rule from the configuration file to execute to address the failure.

6. The computing device of claim 5, including instructions to cause the processing resource to execute the another rule from the configuration file to cause execution of the software application.

7. The computing device of claim 1, wherein the keyword of the error is associated with a particular failure type of the failure.

8. The computing device of claim 7, wherein the failure type is associated with a plurality of rules included in the configuration file executable to address the failure having the particular failure type.

9. The computing device of claim 1, wherein the configuration file is located locally on the computing device.

10. The computing device of claim 1, wherein the configuration file is located externally from the computing device.

11. A non-transitory computer readable medium storing instructions executable by a processing resource to cause the processing resource to:
receive an error code corresponding to a failure during an execution of a software application;
determine, based on a keyword included in the error code, a rule from a plurality of rules included in a modifiable configuration file to execute to address the failure; and
execute the rule to address the failure to cause execution of the software application.

12. The medium of claim 11, wherein the rule includes an associated error code, a retry strategy, and a rule execution order.

13. The medium of claim 11, wherein the rule is a default rule.

14. The medium of claim 13, including instructions to cause execution of a further rule from the plurality rules in response to the default rule causing an unsuccessful execution of the software application.

15. The medium of claim 11, wherein the configuration file is a file that is parsable by a computing device.

16. A method, comprising:
receiving, by a computing device, an error code corresponding to a failure during an execution of a software application;
determining, by the computing device based on a keyword included in the error code, a group of rules selected from a plurality of rules included in a configuration file to execute to address the failure;
executing, by the computing device, a default rule from the group of rules to address the failure to cause execution of the software application; and
in response to the default rule failing to cause a successful execution of the software application, executing, by the computing device, a second rule from the group of rules to cause execution of the software application.

17. The method of claim 16, wherein the method includes modifying, by the computing device, the configuration file by adding a rule to the configuration file.

18. The method of claim 17, wherein the method includes executing, by the computing device, the added rule to cause execution of the software application.

19. The method of claim 17, wherein the method includes adding, by the computing device, the rule to the configuration file without re-compiling instructions comprising the software application.

20. The method of claim 16, wherein:
each rule in the group of rules includes a predefined rule execution order; and
the method includes executing, by the computing device, rules in the group of rules according to the predefined rule execution order until a particular rule in the group of rules causes a successful execution of the software application.
